(19) United States
(12) Patent Application Publication
(10) Pub. No.: US 2001/0021009 A1
(43) Pub. Date: Sep. 13, 2001

(54) METHOD AND APPARATUS FOR CONTROLLING TRAJECTORY IN A SCAN AND STEP WAFER STEPPER

(76) Inventors: BAUSAN YUAN, SAN JOSE, CA (US); JAMES MINOR, LOS ALTOS, CA (US)

Correspondence Address: ROBERT A SALTZBERG, MORRISON & FOERSTER, 425 MARKET STREET, SAN FRANCISCO, CA, 941052482

(21) Appl. No.: 09/143,280

(22) Filed: Aug. 28, 1998

(51) Int. Cl. G03B 27/42

(52) U.S. Cl. 355/53

(57) ABSTRACT

A method and apparatus for controlling trajectory in a scan and step wafer stepper are described. A control computer controls the motion of a stage by accelerating the stage during an acceleration period. The computer commands the stage to move at a constant velocity during a working period that starts after an end of the acceleration period, so that acceleration of the stage is continuous at the endpoints of the acceleration period. The stage is accelerated and moved so that jerk of the stage is zero and continuous at the endpoints of the acceleration period. The stage may be adapted to support a workpiece. The workpiece may be a semiconductor wafer, in which case the computer causes the wafer to be exposed to radiation during the working period.

### BACKGROUND

1. Field of the Invention

The present invention relates to semiconductor manufacturing, and more particularly to controlling the trajectory of a wafer in a wafer stepper.

2. Description of the Related Art

During the manufacture of integrated circuits, circuit patterns for multiple chips are made on a single semiconductor wafer using techniques such as ultraviolet photolithography. FIG. 1 is a simplified block diagram illustrating a wafer scanner-stepper such as the Nikon Model NSR 201, used in the manufacture of semiconductor chips. A radiant energy source 100, such as an ultraviolet light, is directed towards a reticle or mask 102. The light passing through the mask falls on an exposure area of a wafer 104. As a result, the area of the reticle illuminated by the light projects a corresponding pattern onto the exposure area of the wafer. The wafer 104 rests on a wafer stage 106. The wafer stage 106 includes mechanics such as motors and other actuators, which are controlled by a feedback wafer controller 108. The position of the wafer 104 is detected by a wafer position sensor 110, which can be implemented with a laser interferometer, for example.

The reticle may be held by a two-part reticle stage structure, which includes a fine motion stage 112 and a coarse motion stage 114. The coarse stage motion is controlled by a coarse stage controller 116, and the fine stage motion is controlled by a fine stage controller 118. The position of the reticle is sensed by a reticle position sensor 120, which can be implemented by a laser interferometer, for example. The present invention can be employed with this system or with many other scanner-steppers known in the art, and can use any appropriate sensor known in the art.

The scanner-stepper operates as follows. A control computer 122 generates commands specifying the position of the wafer. In response, the wafer controller 108 moves the wafer stage 106. The actual position of the wafer 104 is detected by the wafer sensor 110 and is fed back to a first adder 124. The difference between the commanded position and the sensed position is the following error of the wafer stage. The wafer controller 108 adjusts the position of the wafer stage 106 in response to this error.

Because of limitations on the resolving power of projection lenses used in the light source 100, the wafer is typically exposed to only a small area of the reticle mask 102 to maintain a high resolution. The reticle motion is synchronized with the wafer motion to expose more of the reticle to the wafer. Typically, the coarse controller 116 first moves the coarse reticle stage 114 in a coarse adjustment. The reticle sensor 120 feeds the position of the reticle to a second adder 126, which compares the sensed reticle position to the sensed wafer position. The difference is the synchronization error, which is used by the fine controller 118 to adjust the fine reticle stage 112 in order to minimize the synchronization error.

During exposure, the wafer 104 is scanned with the mask pattern at a constant velocity. Scanning is performed on a row of chip areas laid out in the Y direction. According to the prior art, when the end of a row is reached, motion in the Y direction is halted. At that time, the control computer 122 inputs a command to step the wafer in the orthogonal X direction so that scanning may proceed on the next row. After stepping, motion in the X direction is halted and scanning begins in the reverse Y direction. As a result, the wafer is moved in a serpentine pattern. The reticle 102 tracks the wafer during scanning, but not during stepping.

FIG. 2 illustrates the scan and step pattern in more detail. Scanning begins at point O. In this example, segments AB and EF are areas during which the wafer is exposed to illumination by the radiant energy source. The control computer inputs a command to move the wafer from point O to point A. During segment OA, the wafer stage (and corresponding reticle stages) are accelerated to a constant velocity, which is maintained during the exposure or working interval AB.

The wafer velocity, acceleration and jerk are illustrated in FIG. 3 for two exemplary command inputs. According to one input scheme as shown in the solid lines, acceleration takes a triangular form, and jerk (the derivative of acceleration) takes the form of a square wave during the acceleration interval. According to the command input shown in dashed lines, acceleration takes the form of a fifth order polynomial.

In both cases, the entire scanning interval must be represented by a piecewise function because of discontinuities between the acceleration (and deceleration) intervals and the exposure interval in which velocity is constant. Sharp discontinuities occur at the endpoints O and A of the acceleration interval and endpoints B and C of the deceleration interval. The discontinuities excite the base structure upon which the scanner-stepper rests. These excitations extend the length of time required for the scanner-stepper to settle into a constant velocity, thereby hampering throughput.

After the appropriate chip area has been exposed, the control computer instructs the wafer stage to decelerate to come to a stop at point C. The control computer then instructs the wafer controller to step the wafer stage in the X direction to point D, at which point the computer instructs the wafer controller to accelerate the stage in the reverse Y direction to a constant velocity at point E, so that exposure may take place during exposure interval EF.

For more information on serpentine scanning, please refer to U.S. Pat. No. 4,818,885, issued to Davis et al, which is incorporated by reference herein. For a description of synchronizing a wafer table with a scanning beam, please refer to U.S. Pat. No. 3,900,737, issued to Collier et al., which is incorporated by reference herein. Also, reference may be made to U.S. Pat. No. 5,477,304, issued to Nishi, which is incorporated by reference herein.

It is desired to achieve a smoother scan and step motion so as to avoid the disadvantages resulting from the discontinuities inherent in the prior art.

### SUMMARY OF THE INVENTION

The present invention provides a method and apparatus for controlling trajectory in a scan and step wafer stepper. A control computer controls the motion of a stage by accelerating the stage during an acceleration period. The stage may be accelerated according to a well-behaved, bounded continuous function. The computer commands the stage to move at a constant velocity during a working period that starts after an end of the acceleration period, so that acceleration of the stage is continuous at the endpoints of the acceleration period. The stage is accelerated and moved so that jerk of the stage is zero and continuous at the endpoints of the acceleration period. The stage may be adapted to support a workpiece. The workpiece may be a semiconductor wafer, in which case the computer causes the wafer to be exposed to radiation during the working period.

The computer may accelerate and move the stage in a first direction, and also move the stage in a second direction during a step period that starts after an end of the working period. The stage motion is stopped in the second direction at an end of the step period. Stage motion may be decelerated in the first direction during the step period, and moved at a constant velocity in a reverse first direction after the end of the step period. Acceleration of the stage in the second direction is continuous at the start and end of the step period. Jerk is zero and continuous in the first and second directions at the start and end of the step period. The first direction may be orthogonal to the second direction.

In addition, system controllers may synchronize motion of a tracking member, such as a reticle, with motion of the stage in the first direction during the working period, and decelerate the stage in the first direction during the step period. The stage is also moved in a second direction during the step period. Motion of the tracking member is synchronized during the step period with motion of the stage in the first direction, but not the second direction.

Unlike the prior art, the system of the invention is commanded to move the stage in a first direction during a working period, and to move the stage in both first and second directions during the step period that starts after the end of the working period. The first and second directions may be orthogonal, such as the respective scanning and stepping directions of a semiconductor wafer supported by the stage.

### BRIEF DESCRIPTION OF THE DRAWINGS

FIG. 1 is a simplified block diagram illustrating a wafer scanner-stepper.

FIG. 2 illustrates a prior art scan-and-step pattern.

FIG. 3 illustrates velocity, acceleration and jerk for two exemplary command inputs.

FIG. 4 illustrates a scan-and-step method of the present invention.

FIG. 5 illustrates velocity and acceleration functions according to the present invention.

FIG. 6 illustrates an acceleration function for specified parameters according to the present invention.

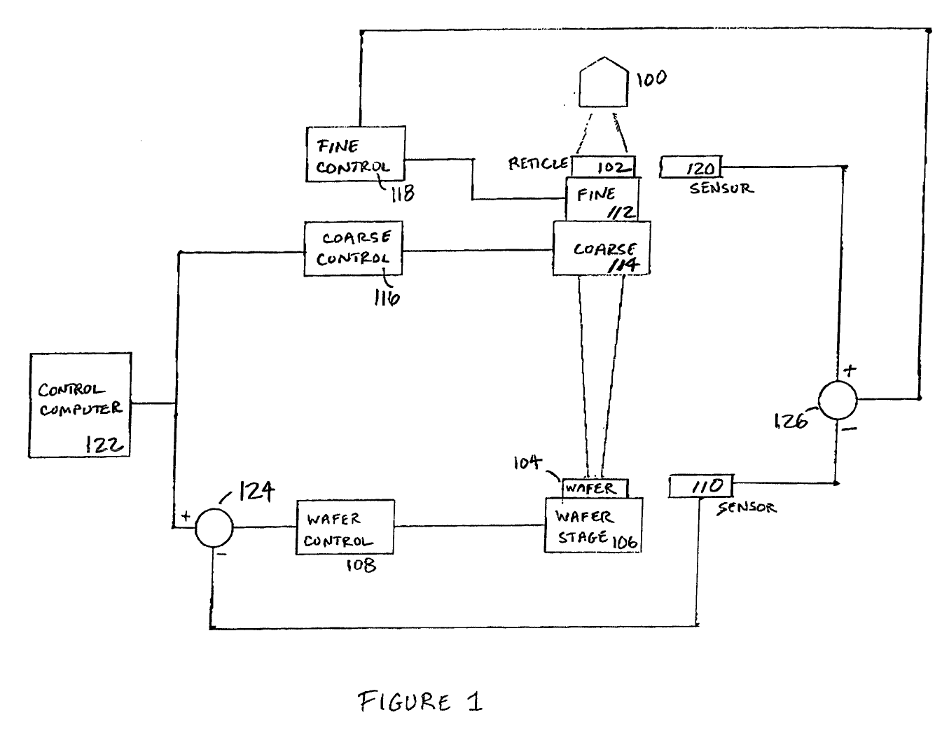

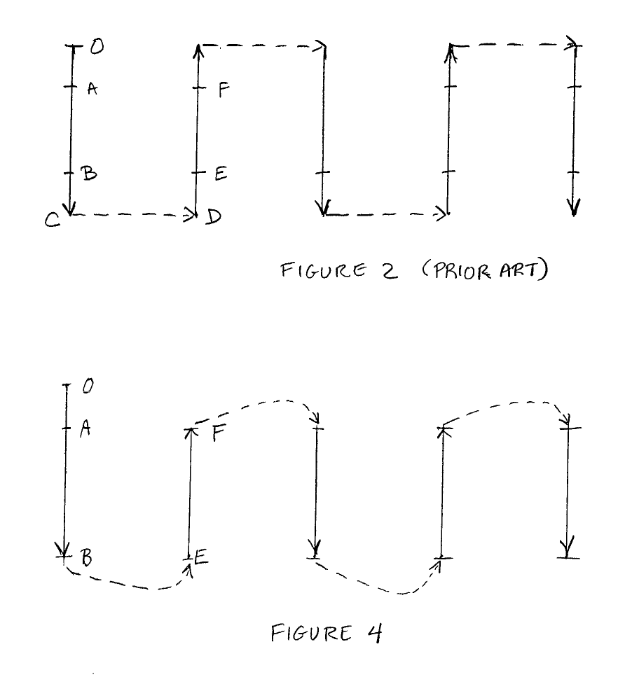

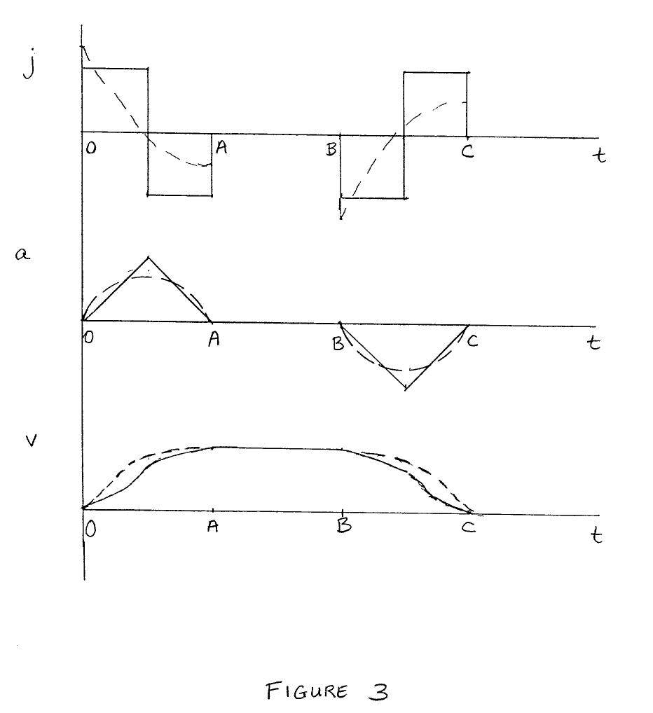

### DETAILED DESCRIPTION OF THE INVENTION

The present invention provides a method and apparatus for controlling trajectory in a scan and step wafer stepper. In the following description, numerous details are set forth in order to enable a thorough understanding of the present invention. However, it will be understood by those of ordinary skill in the art that these specific details are not required in order to practice the invention. Further, well-known elements, devices, process steps and the like are not set forth in detail in order to avoid obscuring the present invention.

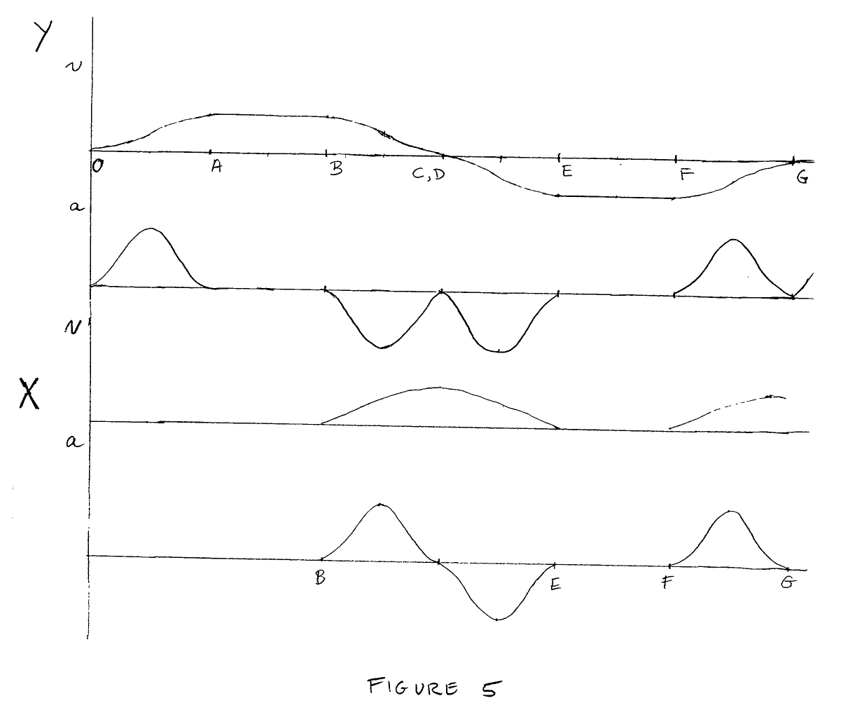

FIG. 4 illustrates the improved scan and step method of the present invention. The input acceleration or force function from the control computer is selected so that acceleration in the Y direction is continuous at the endpoints of the acceleration and deceleration periods, and more particularly at the endpoints of the scan and step periods. Further, jerk of the stage is zero and continuous at those endpoints. In addition, as shown in FIG. 4, motion of the wafer stage in the Y direction is not halted during stepping in the X direction. In general, the present invention employs well-behaved, bounded continuous force functions, i.e., bounded functions that are continuous for all derivatives. Moreover, unlike known systems, the reticle tracks (follows movement of) the wafer stage in the Y (but not X) direction during stepping, not just during scanning.

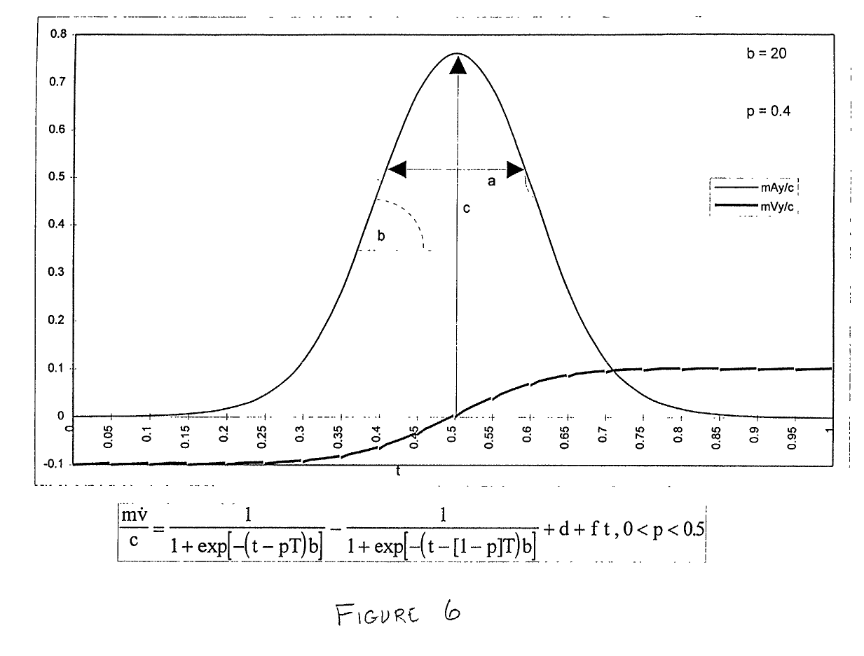

In one embodiment, a force function satisfying these characteristics is illustrated in FIG. 5. Note that the midpoint of step interval BE has been denoted by the point (C,D) for easy comparison with prior figures. The control computer 122 (in conjunction with the wafer controller 108) applies one-half the duration of the force function in the Y direction during the acceleration interval OA, and applies the negative of the entire force function (i.e., in reverse Y direction) during the step interval BE., As shown in FIG. 5, the force function is applied in the reverse Y direction during the step interval BE: (1) to bring the stage to a halt during deceleration interval B(C,D), and (2) to accelerate the stage in the reverse Y direction during (reverse) acceleration interval (C,D)E so that it reaches constant velocity at point E. Motion in the Y direction during the step interval is one distinction over the prior art.

In the X direction, the control computer 122 (in conjunction with the wafer controller 108) causes the wafer stage to accelerate and then decelerate so that motion in the X direction is halted at endpoint E of the exposure interval in the reverse Y direction.

Note that the circuitry (i.e., hardware, software and/or firmware) that controls stage motion (e.g., acceleration, deceleration, constant-velocity motion) may be implemented in a number of ways, and the required functionality may be distributed over different circuits or combined in one circuit in any manner known in the art.

Now that the conceptual groundwork has been laid for an understanding of the present invention, one set of equations characterizing the force function will be described. The following representation of the force function in the step interval can uniformly approximate any continuous function. This exemplary bounded, well-behaved function is a sigmoidal function generally, and a logistic function in particular. (For further reference, see Halbert White, Artificial Neural Networks Approximation and Learning Theory, Blackwell, Cambridge, Mass., 1992, which is incorporated by reference herein.)

$$\frac{ⅆ v}{ⅆ t} = {\sum }_{j = 1}^{n} \frac{c}{1 + exp [ - ( t - {a}_{j} ) {b}_{j} ]} \qquad ( 1 )$$

Integration of this logistic function gives

$$\begin{matrix}v = {\sum }_{j = 1}^{n} \frac{1}{{b}_{j}} {c}_{j} ln [ 1 + exp [ ( - t + {a}_{j} ) - {b}_{j} ] ] - \\ \frac{1}{{b}_{j}} {c}_{j} ln [ exp [ ( - t + {a}_{j} ) {b}_{j} ] ]\end{matrix} \qquad ( 2 )$$

The greater the complexity of the force function, the larger the value of n necessary to represent the function. Since the illustrated step interval has basically two segments: a deceleration segment B(C,D)(e.g., in forward Y direction); and an acceleration segment (C,D)E (e.g., in reverse Y direction), the simplest function over that interval requires n=2 plus a function for endpoint constraints, as follows:

$$\begin{matrix}m \dot{v} = \frac{c}{1 + exp [ - ( t - {a}_{1} ) {b}_{1} ]} - \frac{c}{1 + exp [ - ( t - {a}_{2} ) {b}_{2} ]} + \\ d + ft , {a}_{2} > {a}_{1}\end{matrix} \qquad ( 3 )$$

This equation represents one of the segments or “humps” of the function. As shown, the segments may be symmetric, time-shifted versions of each other. In another embodiment, the segments may overlap partially or completely so as to form one hump.

Integration over duration T of one segment of the step interval for a wafer stage of mass m gives

$$\begin{matrix}\frac{2 mv}{c} = {b}_{1}^{- 1} ln [ 1 + exp [ - ( T - {a}_{1} ) {b}_{1} ] ] - \\ {b}_{1}^{- 1} ln [ exp [ - ( T - {a}_{1} ) {b}_{1} ] ] - \\ {b}_{1}^{- 1} ln [ 1 + exp [ {a}_{1} {b}_{1} ] ] + {b}_{1}^{- 1} ln [ exp [ {a}_{1} {b}_{1} ] ] - \\ {b}_{2}^{- 1} ln [ 1 + exp [ - ( T - {a}_{2} ) {b}_{2} ] ] + \\ {b}_{2}^{- 1} ln [ exp [ - ( T - {a}_{2} ) {b}_{2} ] ] + {b}_{2}^{- 1} ln [ exp [ - ( T - {a}_{2} ) {b}_{2} ] ] + \\ {b}_{2}^{- 1} ln [ 1 + exp [ {a}_{2} {b}_{2} ] ] - {b}_{2}^{- 1} ln [ exp [ {a}_{2} {b}_{2} ] ] + ⅆ T + \frac{{fT}^{2}}{2}\end{matrix} \qquad ( 4 )$$

The variables d and f must satisfy the endpoint constraints \dot{v}(0)=0, \dot{v}(T)=0, where time 0 represents one endpoint of the segment interval, e.g., B, and time T represents the other endpoint, e.g., (C,D).

For a typical symmetric force function,

b₁=b₂=b>0

a₁=pT

a₂=(1−p)T

0<p<0.5

In this case, there are three parameters which determine the shape of the force function in the Y direction: b, p, c. Given these three design parameters, the above expression relates the specified constant-zone velocity v to the total duration of the step interval 2T. Note that T (or 2T) is based upon throughput requirements and geometry of the circuit, e.g., circuit dimensions in the step direction. FIG. 6 illustrates the acceleration function for b=20, p=0.4 and T=1 (normalized), where a=a₂−a₁. The user may specify the maximum constant velocity and the step time, e.g., 2T. The system designer selects c, which determines maximum acceleration (force), based upon motor power. The parameter b represents the slope of the acceleration or jerk. Based on experience, b is selected to avoid excessive excitation of the machine structure. Based on these conditions, the parameter a is determined.

For a given T, one can specify another set of b, p, c, and v for the requisite force function for sidewise motion in the X direction.

The motion parameters in the Y scanning direction were selected with the objective of obtaining a predetermined constant scanning velocity during a minimum step duration 2T with acceptable smoothness. For motion in the orthogonal X step direction, the primary objectives are motion in a specific distance (e.g., BE) in the step duration 2T with acceptable smoothness. Constant position, not constant velocity, is desired at the end of the step.

In order to obtain a closed form solution, a general velocity function similar to the force function used previously is employed. Since the step interval must create and dissipate sideways velocity, the simplest function over the zone requires n=2 plus a function for endpoints constraints as follows:

$$\begin{matrix}v = \frac{c}{1 + exp [ - ( t - {a}_{1} ) {b}_{1} ]} - \\ \frac{c}{1 + exp [ - ( t - {a}_{2} ) {b}_{2} ]} = ⅆ + ft , {a}_{2} > {a}_{1}\end{matrix} \qquad ( 5 )$$

In the X direction, the velocity thus takes the form of a well-behaved, bounded continuous function, e.g., a logistic function. In this example, the force function has only one hump during the step interval Tₓ, where Tₓ=2T. Note that the acceleration or force function is easily calculated by differentiation and is illustrated in FIG. 5.

Integration over step duration Tₓ gives

$$\begin{matrix}\frac{x}{c} = {b}_{1}^{- 1} ln [ 1 + exp [ - ( {T}_{x} - {a}_{1} ) {b}_{1} ] ] - \\ {b}_{1}^{- 1} ln [ exp [ - ( {T}_{x} - {a}_{1} ) {b}_{1} ] ] - \\ {b}_{1}^{- 1} ln [ 1 + exp [ {a}_{1} {b}_{1} ] ] + {b}_{1}^{- 1} ln [ exp [ {a}_{1} {b}_{1} ] ] - \\ {b}_{2}^{- 1} ln [ 1 + exp [ - ( {T}_{x} - {a}_{2} ) {b}_{2} ] ] + \\ {b}_{2}^{- 1} ln [ exp [ - ( {T}_{x} - {a}_{2} ) {b}_{2} ] ] + {b}_{2}^{- 1} ln [ exp [ - ( {T}_{x} - {a}_{2} ) {b}_{2} ] ] + \\ {b}_{2}^{- 1} ln [ 1 + exp [ {a}_{2} {b}_{2} ] ] - {b}_{2}^{- 1} ln [ exp [ {a}_{2} {b}_{2} ] ] + ⅆ x + \frac{{fT}^{2}}{2}\end{matrix}$$

The parameters d and f satisfy the boundary conditions v(0)=0,v(Tₓ)=0, \dot{v}(0)=0, \dot{v}(Tₓ)=0.

For a typical symmetric function,

b₁=b₂=b>0

a₁=pTₓ

a₂=(1−P)Tₓ

0<p<0.5

In this case, there are again three parameters which determine the shape of the velocity function: b, p, c, which are different than those used for the scanning force function. Given these three design parameters, the above expression relates the specified distance x to the duration of the step interval Tₓ.

Specification of Tₓ and the maximum constant velocity during the step interval determines the parameter c. The designer specifies maximum acceleration, which determines b, the slope of velocity. These conditions determine a.

As in the Y direction, acceleration of the stage in the X direction is zero and continuous at the endpoints of the step interval, and at the endpoints of the acceleration and deceleration periods within the step interval. Further, jerk is zero in the X direction at those endpoints.

Although the invention has been described in conjunction with particular embodiments, it will be appreciated that various modifications and alterations may be made by those skilled in the art without departing from the spirit and scope of the invention. The invention is not to be limited by the foregoing illustrative details, but rather is to be defined by the appended claims.

What is claimed is:

1. A method for controlling the motion of a stage, the method comprising the steps of:
accelerating the stage during an acceleration period; and
moving the stage at a constant velocity during a working period that starts after an end of the acceleration period, wherein acceleration of the stage is continuous at least one endpoint of the acceleration period.

2. The method of claim 1, wherein jerk of the stage is zero at the at least one endpoint of the acceleration period.

3. The method of claim 1, wherein jerk of the stage is continuous at the at least one endpoint of the acceleration period.

4. The method of claim 1, wherein the stage is adapted to support a workpiece.

5. The method of claim 4, wherein the workpiece is a semiconductor wafer, the method further comprising the step of exposing the wafer to radiation during the working period.

6. The method of claim 1, wherein the accelerating and moving steps respectively include accelerating and moving the stage in a first direction, the method further comprising the steps of:
moving the stage in a second direction during a step period that starts after an end of the working period; and
stopping motion of the stage in the second direction at an end of the step period.

7. The method of claim 6, further comprising the steps of:
decelerating the stage in the first direction during the step period;
moving the stage at a constant velocity in a reverse first direction after the end of the step period.

8. The method of claim 6, wherein the acceleration of the stage in the second direction is continuous at the start and end of the step period.

9. The method of claim 6, wherein jerk in the first and second directions is zero at the start and end of the step period.

10. The method of claim 6, wherein jerk is continuous at the start and end of the step period.

11. The method of claim 6, wherein the first direction is orthogonal to the second direction.

12. The method of claim 1, wherein the accelerating and moving steps respectively include accelerating and moving the stage in a first direction, the method further comprising the steps of:
synchronizing motion of a tracking member with the motion of the stage in the first direction during the working period; and
decelerating the stage in the first direction during a step period that starts after the end of the working period,
moving the stage in a second direction during the step period;
synchronizing motion of the tracking member during the step period with motion of the stage in the first direction, but not the second direction.

13. The method of claim 12, wherein the tracking member is a reticle.

14. A method for controlling the motion of a stage, the method comprising the steps of:
moving the stage in a first direction during a working period;
moving the stage in the first direction and a second direction during a step period that starts after the end of the working period.

15. The method of claim 14, wherein the first and second directions are orthogonal.

16. The method of claim 14, wherein the first direction is a scanning direction and the second direction is a stepping direction of a semiconductor wafer supported by the stage.

17. A method for controlling the motion of a stage, the method comprising the steps of:
accelerating the stage during an acceleration period, wherein the stage is accelerated according to a well-behaved bounded continuous function; and
moving the stage at a constant velocity during a working period that starts after an end of the acceleration period.

18. The method of claim 17, wherein the function comprises at least one sigmoidal function.

19. The method of claim 17, wherein the function comprises at least one logistic function.

20. A system for controlling the motion of a stage, the system comprising:
means for accelerating the stage during an acceleration period; and
means for moving the stage at a constant velocity during a working period that starts after an end of the acceleration period, wherein acceleration of the stage is continuous at least one endpoint of the acceleration period.

21. The system of claim 20, wherein jerk of the stage is zero at the at least one endpoint of the acceleration period.

22. The system of claim 20, wherein jerk of the stage is continuous at the at least one endpoint of the acceleration period.

23. The system of claim 20, wherein the stage is adapted to support a workpiece.

24. The system of claim 23, wherein the workpiece is a semiconductor wafer, the system further comprising a radiation source for exposing the wafer to radiation during the working period.

25. The system of claim 20, wherein the means for accelerating and means for moving respectively accelerate and move the stage in a first direction, the system further comprising:
means for moving the stage in a second direction during a step period that starts after an end of the working period; and
means for stopping motion of the stage in the second direction at an end of the step period.

26. The system of claim 25, further comprising:
means for decelerating the stage in the first direction during the step period; and
means for moving the stage at a constant velocity in a reverse first direction after the end of the step period.

27. The system of claim 25, wherein the acceleration of the stage in the second direction is continuous at the start and end of the step period.

28. The system of claim 25, wherein jerk in the first and second directions is zero at the start and end of the step period.

29. The system of claim 25, wherein jerk is continuous at the start and end of the step period.

30. The system of claim 25, wherein the first direction is orthogonal to the second direction.

31. The system of claim 20, wherein the means for accelerating and means for moving respectively accelerate and move the stage in a first direction, the system further comprising:
tracking means for tracking motion of a tracking member with the motion of the stage in the first direction during the working period; and
means for decelerating the stage in the first direction during a step period that starts after the end of the working period,
means for moving the stage in a second direction during the step period,
wherein the tracking means tracks motion of the tracking member during the step period with motion of the stage in the first direction, but not the second direction.

32. The system of claim 31, wherein the tracking member is a reticle.

33. A system for controlling the motion of a stage, the system comprising:
means for moving the stage in a first direction during a working period and during a step period that starts after the end of the working period; and
means for moving the stage in a second direction during the step period while the stage is moving in the first direction.

34. The system of claim 33, wherein the first and second directions are orthogonal.

35. The system of claim 33, wherein the first direction is a scanning direction and the second direction is a stepping direction of a semiconductor wafer supported by the stage.

36. A system for controlling the motion of a stage, the system comprising:
means for accelerating the stage during an acceleration period, wherein the stage is accelerated according to a well-behaved, bounded continuous function; and
means for moving the stage at a constant velocity during a working period that starts after an end of the acceleration period.

37. The method of claim 34, wherein the function comprises at least one sigmoidal function.

38. The method of claim 34, wherein the function comprises at least one logistic function.

39. A scanning exposure method comprising the steps of:
accelerating the stage during an acceleration period;
moving the stage at a constant velocity during an exposure period that starts after an end of the acceleration period, wherein acceleration of the stage is continuous at least one endpoint of the acceleration period; and
projecting a pattern in a direction towards the stage during the exposure period.

40. The method of claim 39, wherein jerk of the stage is zero at the at least one endpoint of the acceleration period.

41. The method of claim 39, wherein jerk of the stage is continuous at the at least one endpoint of the acceleration period.

42. The method of claim 39, the projecting step comprising the step of exposing the pattern onto a wafer supported by the stage.

43. The method of claim 39, wherein the accelerating and moving steps respectively include accelerating and moving the stage in a scan direction, the method further comprising the steps of:
moving the stage in a step direction during a step period that starts after an end of the exposure period; and
stopping motion of the stage in the step direction at an end of the step period.

44. The method of claim 43, further comprising the steps of:
decelerating the stage in the scan direction during the step period;
moving the stage at a constant velocity in a reverse scan direction after the end of the step period.

45. The method of claim 43, wherein the acceleration of the stage in the step direction is continuous at the start and end of the step period.

46. The method of claim 43, wherein jerk in the scan and step directions is zero at the start and end of the step period.

47. The method of claim 43, wherein jerk is continuous at the start and end of the step period.

48. The method of claim 39, wherein the accelerating and moving steps respectively include accelerating and moving the stage in a scan direction, the method further comprising the steps of:
synchronizing motion of a reticle with the motion of the stage in the scan direction during the exposure period; and
decelerating the stage in the scan direction during a step period that starts after the end of the exposure period,
moving the stage in a step direction during the step period;
synchronizing motion of the reticle during the step period with motion of the stage in the scan direction, but not the step direction.

49. A scanning exposure method comprising the steps of:
moving a stage in a scan direction during an exposure period;
projecting a pattern in a direction towards the stage during the exposure period; and
moving the stage in the scan direction and a step direction during a step period that starts after the end of the exposure period.

50. The method of claim 49, wherein the projecting step comprises the step of projecting a pattern onto a wafer supported by the stage.

51. A scanning exposure method comprising the steps of:
accelerating a stage at a constant velocity during an acceleration period, wherein the stage is accelerated according to a well-behaved bounded continuous function;
moving the stage at a constant velocity during an exposure period that starts after an end of the acceleration period; and
projecting a pattern in a direction towards the stage during the exposure period.

52. The method of claim 1, wherein the function comprises at least one sigmoidal function.

53. The method of claim 51, wherein the function comprises at least one logistic function.

54. A scanning exposure system comprising:
means for accelerating a stage during an acceleration period;
means for moving the stage at a constant velocity during an exposure period that starts after an end of the acceleration period, wherein acceleration of the stage is continuous at least one endpoint of the acceleration period; and
an energy source for projecting a pattern in a direction towards the stage during the exposure period.

55. The system of claim 54, wherein jerk of the stage is zero at the at least one endpoint of the acceleration period.

56. The system of claim 54, wherein jerk of the stage is continuous at the at least one endpoint of the acceleration period.

57. The system of claim 54, further comprising a wafer supported by the stage.

58. The system of claim 54, wherein the means for accelerating and means for moving respectively accelerate and move the stage in a scan direction, the system further comprising:
means for moving the stage in a step direction during a step period that starts after an end of the exposure period; and
means for stopping motion of the stage in the step direction at an end of the step period.

59. The system of claim 58, further comprising:
means for decelerating the stage in the scan direction during the step period; and
means for moving the stage at a constant velocity in a reverse scan direction after the end of the step period.

60. The system of claim 58, wherein the acceleration of the stage in the step direction is continuous at the start and end of the step period.

61. The system of claim 58, wherein jerk in the scan and step directions is zero at the start and end of the step period.

62. The system of claim 58, wherein jerk is continuous at the start and end of the step period.

63. The system of claim 54, wherein the means for accelerating and means for moving respectively accelerate and move the stage in a scan direction, the system further comprising:
tracking means for tracking motion of a reticle with the motion of the stage in the scan direction during the exposure period;
means for decelerating the stage in the scan direction during a step period that starts after the end of the exposure period;
means for moving the stage in a step direction during the step period,
wherein the tracking means tracks motion of the reticle during the step period with motion of the stage in the scan direction, but not the step direction.

64. A scanning exposure system comprising:
means for moving a stage in a scan direction during an exposure period and during a step period that starts after the end of the working period;
means for moving the stage in a step direction during the step period while the stage is moving in the scan direction; and
an energy source for projecting a pattern in a direction towards the stage during the exposure period.

65. A scanning exposure system comprising:
means for accelerating a stage at a constant velocity during an acceleration period, wherein the stage is accelerated according to a well-behaved, bounded continuous function;
means for moving the stage at a constant velocity during an exposure period that starts after an end of the acceleration period; and
an energy source for projecting a pattern in a direction towards the stage during the exposure period.

66. The method of claim 65, wherein the function comprises at least one sigmoidal function.

67. The method of claim 65, wherein the function comprises at least one logistic function.
